(19) United States
(12) Patent Application Publication
(10) Pub. No.: US 2014/0055849 A1
(43) Pub. Date: Feb. 27, 2014

(54) LIGHT DIFFUSION PLATE, DISPLAY APPARATUS HAVING THE SAME, AND METHOD OF MANUFACTURING THE LIGHT DIFFUSION PLATE

(71) Applicant: SAMSUNG DISPLAY CO., LTD., Yongin-City (KR)

(72) Inventors: Ju-Youn SON, Asan-si (KR); Jin SEO, Osan-si (KR); Ju-Hwa HA, Asan-si (KR)

(73) Assignee: SAMSUNG DISPLAY CO., LTD., Yongin-City (KR)

(21) Appl. No.: 13/739,119

(22) Filed: Jan. 11, 2013

(30) Foreign Application Priority Data
Aug. 24, 2012 (KR) 10-2012-0093126

(51) Int. Cl. G02B 5/02

(52) U.S. Cl. CPC G02B 5/0215; G02B 5/0242; G02B 5/0268
USPC 359/361; 264/1.29

(57) ABSTRACT

A light diffusion plate includes a body including a first surface through which incident light enters, and a second surface through which light exits and facing the first surface, a light scattering member disposed in the body, and an ultraviolet absorption member disposed in the body. The second surface has a convex pattern. The convex pattern has ridges and valleys arranged in a plurality of columns. The ridges and valleys are sequentially arranged with each other.

This application claims priority to Korean Patent Application No. 10-2012-0093126, filed on Aug. 24, 2012, and all the benefits accruing therefrom under 35 U.S.C. §119, the contents of which in its entirety is herein incorporated by reference.

### BACKGROUND

1. Field

Exemplary embodiments of the invention relate to a light diffusion plate, a display apparatus having the same, and a method of manufacturing the light diffusion plate. More particularly, one or more exemplary embodiment of the invention relates to a light diffusion plate, a display apparatus having the same, and a method of manufacturing the light diffusion plate which can reduce dark-bright spots generated in a direct-illumination type liquid crystal display.

2. Description of the Related Art

Generally, a display apparatus such as a liquid crystal display apparatus includes a display panel having a display area in which an image is displayed and a peripheral area in which a driving part driving the display area is disposed, and a backlight assembly providing light for the display panel.

The backlight assembly is categorized as a direct-illumination type and an edge-illumination type according to a position of a light source. The direct-illumination type backlight assembly includes a plurality of light sources corresponding to substantially an entire of the display panel.

When a light emitting diode (“LED”) is used as the light source, the display apparatus includes a light diffusion plate disposed between the display panel and the backlight assembly. The light diffusion plate diffuses light emitted from the LED.

However, a conventional light diffusion plate has low diffusivity of light. Accordingly, when the conventional light diffusion plate is used in the direct-illumination type backlight assembly, the display panel may display dark-bright spots according to a position of the light source. Therefore, there remains a need for an improved light diffusion plate.

### SUMMARY

One or more exemplary embodiment of the invention provides a light diffusion plate improving diffusivity of light emitted from a direct-illumination type backlight assembly.

One or more exemplary embodiment of the invention also provides a display apparatus including the light diffusion plate.

One or more exemplary embodiment of the invention still also provides a method of manufacturing the light diffusion plate.

In an exemplary embodiment of a light diffusion plate, the light diffusion plate includes a body including a first surface through which incident light enters and a second surface facing the first surface, a light scattering member disposed in the body, and an ultraviolet absorption member disposed in the body. The second surface has a convex pattern. The convex pattern has ridges and valleys arranged in a plurality of columns. The ridges and valleys are sequentially arranged with each other.

In the exemplary embodiment, the convex pattern may have a cross-sectional shape of an arc of an ellipse.

In the exemplary embodiment, the ellipse may satisfy the following equations:

$$\begin{matrix}tan θ = \frac{2 H}{p} = α , & Equation 1 \\ a / b = γ , & Equation 2 \\ H = a - a \sqrt{1 - \frac{{p}^{2}}{4 {b}^{2}}} ↔ {( \frac{H}{p / 2} )}^{2} + {( a / b )}^{2} = ( \frac{H}{p / 2} ) ( \frac{4 α}{p} ) , & Equation 3 \\ a = \frac{p}{4 α} ( {α}^{2} + {γ}^{2} ) , & Equation 4 \\ b = \frac{p}{4} ( \frac{α}{γ} + \frac{γ}{α} ) , \\ and & Equation 5 \\ F = \frac{p}{4 α} ( \frac{α}{γ} + \frac{γ}{α} ) \frac{\sqrt{{γ}^{2} - 1}}{γ} . & Equation 6\end{matrix}$$

θ may represent a distance from a valley to a ridge of the arc, H may represent a height from the valley to the ridge, p may represent a width of the arc, a may represent a semi major axis of the ellipse, b may represent a semi minor axis of the ellipse, and F may represent a focal length of the ellipse, respectively.

In the exemplary embodiment, an angle between a valley to a ridge of the convex pattern may be from about 40 degrees to about 45 degrees with respect to the first surface.

In the exemplary embodiment, a size of the scattering member may be from about 0.1 micrometer to about 4 micrometers.

In the exemplary embodiment, the light scattering member and the ultraviolet absorption member may be disposed in different cross-sectional areas of the body.

In the exemplary embodiment, the light scattering member may be disposed closer to the second surface than the ultraviolet absorption member.

In the exemplary embodiment, a first cross-sectional area of the body may include the light scattering member and a second cross-sectional area of the body may include the ultraviolet absorption member. The first and second cross-sectional areas may exclude each other, or overlap each other.

In the exemplary embodiment, the body may include polycarbonate.

In the exemplary embodiment, the light scattering member may be disposed in the convex pattern.

In an exemplary embodiment of a display apparatus, the display apparatus includes a light source emitting light, a light diffusion plate, and a display panel disposed on the light diffusion plate and displaying an image using light emitted from a light exiting surface of the light diffusion plate. The light diffusion plate includes a body having a light incident surface, and the light exiting surface facing the light incident surface, a light scattering member disposed in the body, and an ultraviolet absorption member disposed in the body. The light exiting surface has a convex pattern. The convex pattern has ridges and valleys sequentially arranged in a plurality of columns.

In the exemplary embodiment, the convex pattern may have a cross-sectional shape of an arc of an ellipse.

In the exemplary embodiment, an angle between a valley to a ridge of the convex pattern is from about 40 degrees to about 45 degrees with respect to the light incident surface.

In the exemplary embodiment, a size of the scattering member may be from about 0.1 micrometer to about 4 micrometers.

In the exemplary embodiment, the light scattering member and the ultraviolet absorption member may be disposed in different cross-sectional areas of the body.

In an exemplary embodiment of a method of manufacturing a light diffusion plate, the method includes mixing a light scattering member with a first resin material to form a first resin, mixing an ultraviolet absorption member with a second resin material to form a second resin, and extruding the first resin or the second resin through a discharge hole to form the light diffusion plate.

In the exemplary embodiment, the extruding the first resin or the second resin through the discharge hole to form the light diffusion plate may include extruding the first resin and the second resin simultaneously through the discharge hole.

In the exemplary embodiment, the extruding the first resin or the second resin through the discharge hole to form the light diffusion plate may include extruding the first resin and the second resin alternately through the discharge hole.

According to one or more exemplary embodiment of the light diffusion plate and the display apparatus, the light diffusion plate may include a body including a single material, a light scattering member and an ultraviolet absorption member disposed in the body, and a light exiting surface of the body having a convex pattern including ridges and valleys sequentially arranged in a plurality of columns, to improve diffusivity of light emitted from the direct-illumination type backlight assembly.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a exploded perspective view showing an exemplary embodiment of a display apparatus according to the invention;

FIG. 2 is a cross-sectional view illustrating an exemplary embodiment of a light diffusion plate according to the invention;

FIG. 3 is an enlarged cross-sectional view illustrating portion ‘A’ of FIG. 2;

FIG. 4 is a graph illustrating size distribution of light scattering members disposed in a light diffusion plate according to the invention;

FIG. 5A is a plan view photograph illustrating diffused light from a backlight assembly using a comparative light diffusion plate including neither a light scattering member nor a convex pattern on a light exiting surface thereof;

FIG. 5B is a plan view photograph illustrating diffused light from a backlight assembly using an exemplary embodiment of a light diffusion plate according to the invention;

FIG. 6 is a block diagram illustrating an exemplary embodiment of a method of manufacturing a light diffusion plate according to the invention;

FIG. 7 is an enlarged cross-sectional view illustrating an exemplary embodiment of a discharge hole of an extruder used in a method of manufacturing a light diffusion plate according to the invention;

FIG. 8 is a cross-sectional view illustrating another exemplary embodiment of a light diffusion plate according to the invention; and

FIG. 9 is a cross-sectional view illustrating still another exemplary embodiment of a light diffusion plate according to the invention.

### DETAILED DESCRIPTION

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

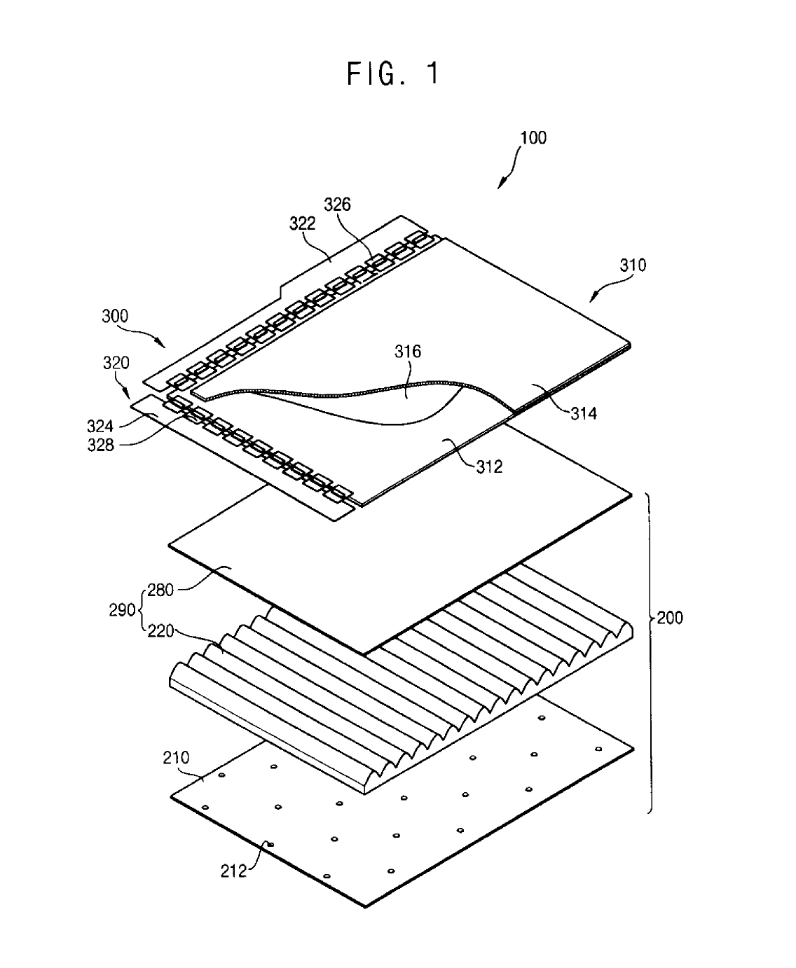

FIG. 1 is an exploded perspective view schematically showing an exemplary embodiment of a display apparatus according to the invention.

Referring to FIG. 1, an exemplary embodiment of a display apparatus 100 includes a backlight assembly 200 generating and providing light, and a display unit 300 displaying an image using the light.

The backlight assembly 200 includes a circuit board 210, a point light source 212 mounted on the circuit board 210 and generating light, and an optical member 290. A plurality of point light sources 212 may be on the circuit board 210.

The circuit board 210 includes a power line (not shown) applying electrical power to the point light source 212 from an external power source (not shown) outside the circuit board 210. The circuit board 210 has a rectangular plate shape. In one exemplary embodiment, the circuit board 210 may include a printed circuit board (“PCB”) or a metal coating printed circuit board (“MCPCB”), but is not limited thereto or thereby.

A plurality of point light sources 212 may be disposed in a plurality of rows and columns on the circuit board 210. The point light source 212 may include a light emitting diode (“LED”). The point light source 212 generates light by the electrical power applied from the power line of the circuit board 210. The point light source 212 may generate a colored light such as red light, green light, blue light or other colored light.

The plurality of point light sources 212 may be arranged at substantially uniform intervals. In one exemplary embodiment, for example, the point light sources 212 may be disposed according to a hexagonal arrangement shifted by a desired interval in an odd row and an even row with respect to a row direction.

The optical member 290 includes a light diffusion plate 220 and a diffusion sheet 280.

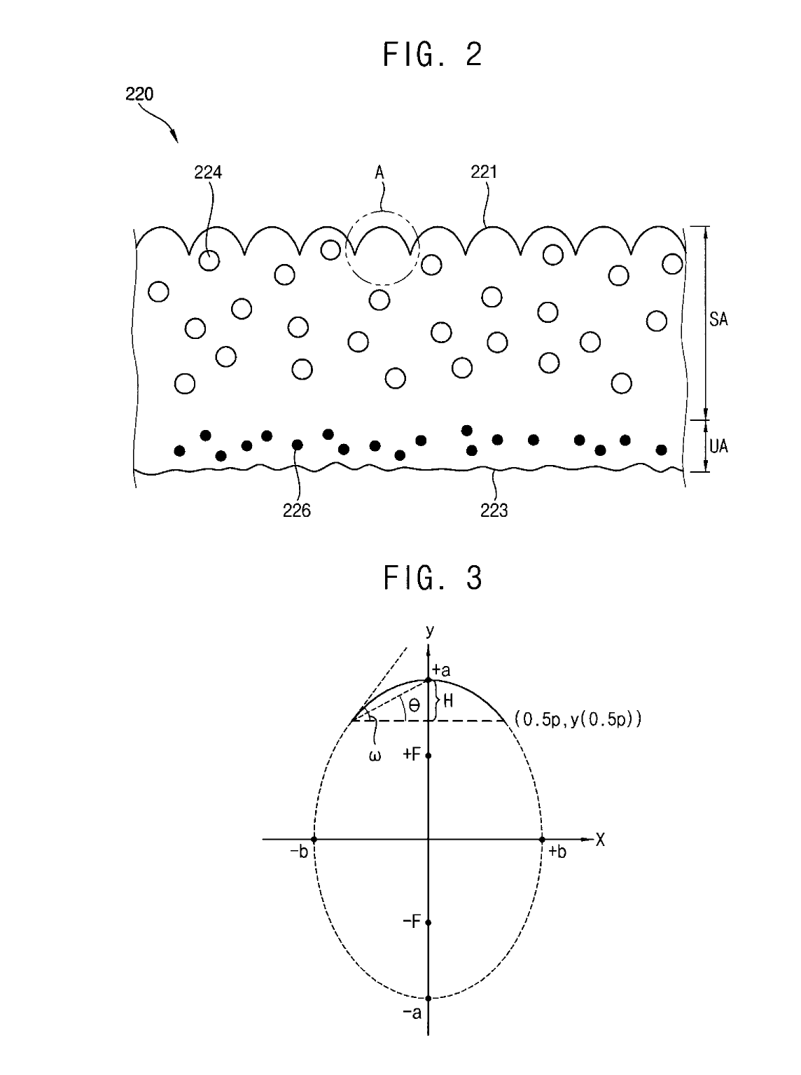

The light diffusion plate 220 improves luminance uniformity of light emitted from the point light sources 212. The light diffusion plate 220 has a plate shape having a desired thickness and includes of transparent material. The light diffusion plate 220 is explained in detail referring to FIGS. 2 and 3.

The diffusion sheet 280 is disposed between the light diffusion plate 220 and the display unit 300. The diffusion plate 280 further improves luminance uniformity of light diffused by the light diffusion plate 220.

Although not shown, the backlight assembly 200 may further include a condensing sheet improving front luminance by condensing the light in a vertical direction, and/or a reflective polarizing sheet increasing luminance by partially transmitting the light and partially reflecting the light.

The display unit 300 includes a display panel 310 displaying images using the light supplied from the backlight assembly 200, and a driving circuit part 320 driving the display panel 310.

The display panel 310 includes an array substrate 312, a facing substrate 314 engaging with the array substrate 312, and a liquid crystal layer 316 disposed between the array substrate 312 and the facing substrate 314.

The array substrate 312 includes a pixel electrode, a gate line and a data line. The array substrate 312 may include a plurality of pixel electrodes arranged in a matrix form, a plurality of gate lines and/or a plurality of data lines. The array substrate 312 further includes a switching element applying a signal to the pixel electrode, the gate line and the data line. In one exemplary embodiment, for example, the gate line may be disposed on the array substrate 312 and include a longitudinal axis which extends in a first direction, and the data line may be disposed on the array substrate 312 and include a longitudinal axis which extends in a second direction crossing the first direction. The switching element may include a source electrode, a drain electrode and a gate electrode. The gate electrode may be electrically connected to the gate line, the source electrode may be electrically connected to the data line and the drain electrode may be electrically connected to the pixel electrode.

The facing substrate 314 includes a common electrode (not shown) including a transparent material. The facing substrate 314 may further include a light-blocking pattern preventing a light-leakage in a peripheral area of the pixel electrode. The light blocking pattern may be disposed to prevent a light leakage in peripheral areas of a plurality of pixel electrodes according to an arrangement of the pixel electrodes.

Alignment of liquid crystal included in the liquid crystal layer 316 changes according to an electric field formed by an electric signal applied to electrodes of the array substrate 312 and the facing substrate 314, respectively. As the alignment of the liquid crystal changes, an amount of light transmitted through the liquid crystal layer 316 is adjusted, and an image is displayed on the display panel 310.

The driving circuit part 320 includes a data PCB 322 applying a data driving signal to the data line, a gate PCB 324 applying a gate driving signal to the gate line, a data driving circuit film 326 electrically connecting the data PCB 322 and the display panel 310 to each other, and a gate driving circuit film 328 electrically connecting the gate PCB 324 and the display panel 310 to each other. The data driving circuit film 326 and/or the gate driving circuit film 328 may include tape carrier package (“TCP”) or chip on film (“COF”), but is not limited thereto or thereby.

FIG. 2 is a cross-sectional view of an exemplary embodiment of a light diffusion plate according to the invention. FIG. 3 is an enlarged cross-sectional view illustrating portion ‘A’ of FIG. 2.

Referring to FIGS. 2 and 3, the light diffusion plate 220 includes a body having a light entering surface 223, and a light exiting surface 221 from which diffused light is emitted and facing the light entering surface 223. The light exiting surface 221 has a first convex pattern including ridges and valleys sequentially arranged according to a plurality of columns. The light entering surface 223 may have a second convex pattern smaller than the first convex pattern and the second convex pattern is an irregular pattern. Each of the ridges and valleys may have a longitudinal axis which is elongated in a same direction as the columns, as illustrated in FIG. 1.

The first convex pattern has a regular convex pattern. In one exemplary embodiment, for example, the first convex pattern may have a shape of an arc of an ellipse. The first convex pattern may include a plurality of the arcs arranged directly adjacent to each other, but is not limited thereto or thereby. Furthermore, a cross-section of the first convex pattern may have an arc shape formed of points having greater y-values on an ellipse defined by a semi major axis as character ‘a’, a semi minor axis as character ‘b’ and a focal length as character F with respect to a point (0.5p, y(0.5p)). An x-axis may be defined by the semi minor axis ‘b’) % while a y-axis may be defined by the semi major axis ‘a’. In exemplary embodiments, for example, the arc may have a valley-to-ridge angle θ from about 40 degrees to about 45 degrees with respect to the x-axis. In one exemplary embodiment, the valley-to-ridge angle θ may be substantially 43 degrees, but is not limited thereto or thereby. Also, the arc may have a tangential angle ω at the valley from about 60 degrees to about 65 degrees. In one exemplary embodiment, the tangential angle ω at the valley may be substantially 63 degrees, but is not limited thereto or thereby.

The ellipse of which points form the first convex pattern may satisfy the following Equations 1 through 6. Hereinafter, θ represents an angle formed by a line from the valley to the ridge of the arc with respect to the x-axis, H represents a height from the valley to the ridge, p represents a width of the arc taken parallel to the x-axis (i.e. connecting two ends of the arc), character ‘a’ represents the semi major axis of the ellipse, character ‘b’ represents the semi minor axis of the ellipse, and F represents the focal length of the ellipse, respectively.

$$\begin{matrix}tan θ = \frac{2 H}{p} = α & Equation 1 \\ a / b = γ & Equation 2 \\ H = a - a \sqrt{1 - \frac{{p}^{2}}{4 {b}^{2}}} ↔ {( \frac{H}{p / 2} )}^{2} + {( a / b )}^{2} = ( \frac{H}{p / 2} ) ( \frac{4 α}{p} ) & Equation 3 \\ a = \frac{p}{4 α} ( {α}^{2} + {γ}^{2} ) & Equation 4 \\ b = \frac{p}{4} ( \frac{α}{γ} + \frac{γ}{α} ) & Equation 5 \\ F = \frac{p}{4 α} ( \frac{α}{γ} + \frac{γ}{α} ) \frac{\sqrt{{γ}^{2} - 1}}{γ} & Equation 6\end{matrix}$$

Referring to FIG. 2 again, the light diffusion plate 220 includes a light scattering member 224 disposed in the body and scattering the light, and an ultraviolet (“UV”) absorption member 226 disposed in the body and absorbing UV light. The light diffusion plate 220 may include a plurality of light scattering members 224 and/or a plurality of UV absorption members 226 disposed in the body thereof.

An entire of the body may include a same material. In one exemplary embodiment, for example, the body of the light diffusion plate 220 may include polycarbonate. The light diffusion plate 220 does not have a multi-layer structure in which a first layer including the light scattering member 224 and a second layer including the UV absorption member 226 are sequentially integrated. Instead, the light diffusion plate 220 has a single layer structure in which the light scattering member 224 and the UV absorption member 226 are included in a same layer while areas of the light diffusion plate 220 in which each member is disposed are the same or different. According to exemplary embodiments of the invention, the light scattering member 224 and the UV absorption member 226 may be disposed in different areas within the body of the light diffusion plate 220, that is, non-overlapping areas where one area excludes another area. Referring to FIG. 2, for example, a first area SA in which the light scattering member 224 is disposed may be closer to the light exiting surface 221 of the light diffusion plate 220 than a second area UA in which the UV absorption member 226 is disposed. As illustrated in FIG. 2, the light scattering member 224 may be included within the first convex pattern, that is, a portion or an entire of the light scattering member 224 may be between the valley and the ridge of an arc.

The light scattering member 224 may include a silicon material such as silicon dioxide, but is not limited thereto or thereby. A particle size of the light scattering member 224 may be from about 0.1 micrometer (μm) to about 4.0 micrometers (μm). In one exemplary embodiment, the particle size of the light scattering member 224 may be substantially 0.8 μm. A particle size range of a plurality of light scattering members 224 may be designed to improve luminance uniformity of the light diffusion plate 220.

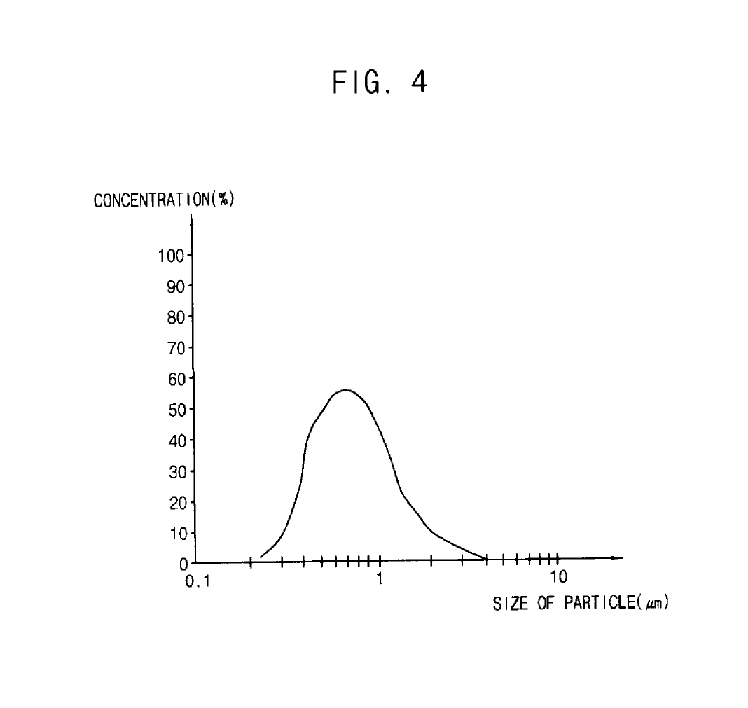

FIG. 4 is a graph illustrating size distribution of light scattering members disposed in an exemplary embodiment of a light diffusion plate according to the invention. Table A represents approximate concentrations in percent (%) with respect to the particle size of the light scattering members.

TABLE A

| Particle size (μm) | Concentration (%) | Accumulated concentration (%) |
|---|---|---|
| 0.31 | 3.26 | 3.26 |
| 0.36 | 6.28 | 9.54 |
| 0.42 | 8.86 | 18.40 |
| 0.49 | 10.79 | 29.19 |
| 0.58 | 11.93 | 41.13 |
| 0.67 | 12.19 | 53.31 |
| 0.78 | 11.55 | 64.86 |
| 0.91 | 10.10 | 74.96 |
| 1.06 | 8.09 | 83.05 |
| 1.24 | 5.86 | 88.91 |
| 1.44 | 3.87 | 92.78 |
| 1.68 | 2.49 | 95.27 |
| 1.95 | 1.82 | 97.09 |
| 2.28 | 1.49 | 98.58 |
| 2.66 | 1.02 | 99.60 |
| 3.09 | 0.40 | 100.00 |

Referring to FIG. 4 and Table A, the particle size distribution of the light scattering members 224 in the exemplary embodiment of the diffusion plate 220 has a right-skewed distribution. Also, the particles size distribution of the light scattering members 224 has a maximum concentration at about 0.8 μm.

The UV absorption member 226 absorbs UV light such as UVA light and/or UVB light emitted from the point light source 212. The UV absorption member 226 may include TINUVIN® 360 (supplied by BASF).

As mentioned above, one or more exemplary embodiment of the light diffusion plate according to the invention may include substantially an entire of the body of a same material, the scattering member and the UV absorption member disposed within the body, and the light exiting surface of the body having the first convex pattern including ridges and valleys sequentially arranged according to a plurality of columns, to improve diffusivity of light emitted from the direct-illumination type backlight assembly.

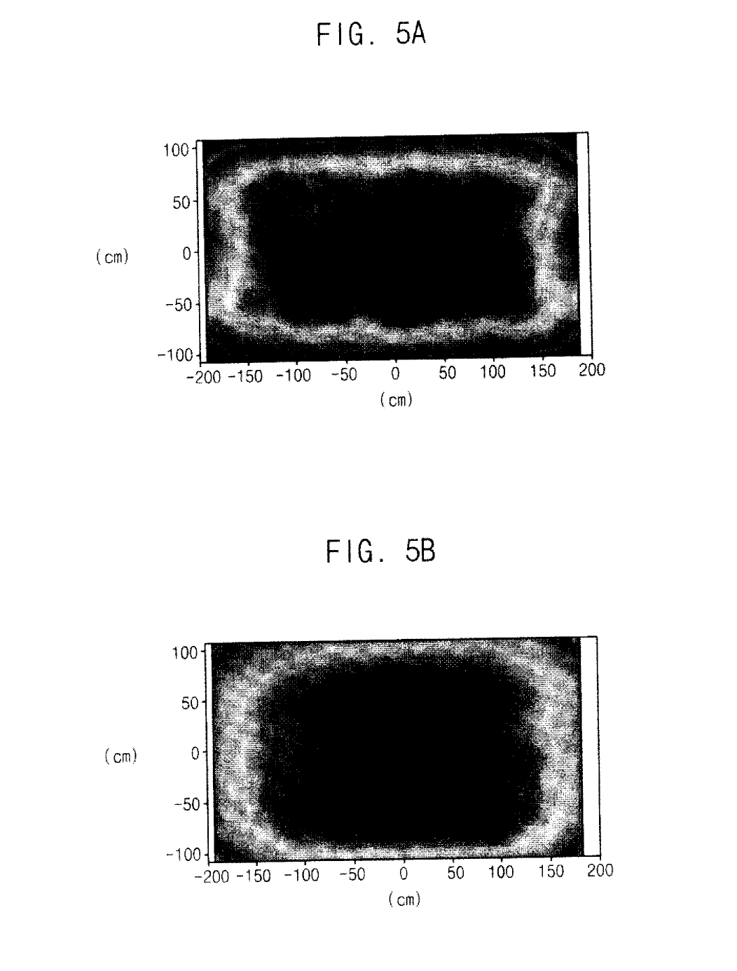

FIG. 5A is a plan view photograph illustrating diffused light from a backlight assembly using a comparative light diffusion plate including neither a light scattering member nor a convex pattern on a light exiting surface thereof FIG. 5B is a plan view photograph illustrating diffused light from a backlight assembly using an exemplary embodiment of a light diffusion plate according to the invention. The diffused light is shown relative to positions taken according to an x-axis and a y-axis both in centimeters (cm).

Referring to FIGS. 5A and 5B, when a light diffusion plate includes neither a light scattering member nor a convex pattern on a light exiting surface thereof, bright-dark spots occurs in an area corresponding to point light sources to reduce luminance uniformity of a direct-illumination type backlight assembly (see FIG. 5A). However, when an exemplary embodiment of the light diffusion plate according to the invention is used in the backlight assembly, diffusivity of light by the light scattering members and the convex pattern increases to improve luminance uniformity of the direct-illumination type backlight assembly (see FIG. 5B).

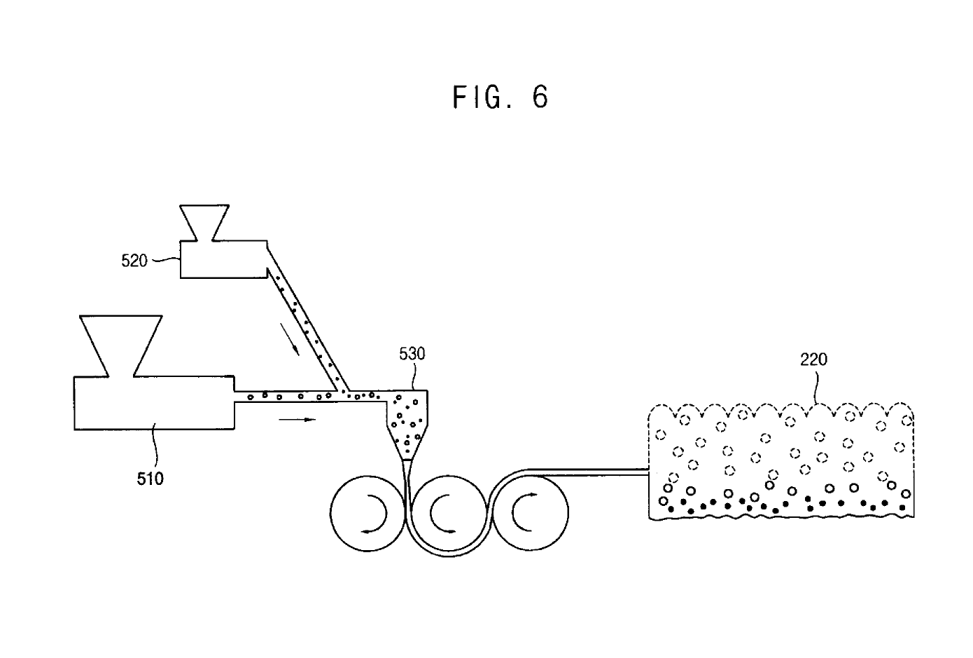

FIG. 6 is a block diagram illustrating an exemplary embodiment of a method of manufacturing a light diffusion plate according to the invention.

Referring to FIG. 6, the light diffusion plate 220 having a single layer structure and including the light scattering member 224 and the UV absorption member 226 may be manufactured such as by using more than one extruder. In particular, the extruders include a first extruder 510 and a second extruder 520. In one exemplary embodiment, for example, the first extruder 510 extrudes a first resin including a first resin material and the light scattering member 224, and the second extruder 520 extrudes a second resin including a second resin material and the UV absorption member 226. The first resin and the second resin may be mixed in a chamber 530. The mixed resin which exits from the chamber via a moving roller and forms the light diffusion plate 220. The formed light diffusion plate 220 may include any one of the above-described exemplary embodiments, such as in including a body including the resin materials, and the light scattering member 224 and the UV absorption member 226 disposed within the body.

Although the first resin and the second resin are mixed in the chamber 530 in FIG. 6, the second resin may be separately extruded from the first resin to form a lower portion of the light diffusion plate 220, and the first resin may be separately extruded from the second resin to form an upper portion of the light diffusion plate 220 according to exemplary embodiments. In one exemplary embodiment, the second resin may be extruded before the first resin, but is not limited thereto or thereby. The first resin and the second resin may be alternately or simultaneously extruded to form a portion of the light diffusion plate 220. According to the portions of the light diffusion plate 220 in which the first resin and the second resin are disposed, the areas of the light diffusion plate 220 in which the light scattering member 224 and the UV absorption member 226 are disposed may be determined.

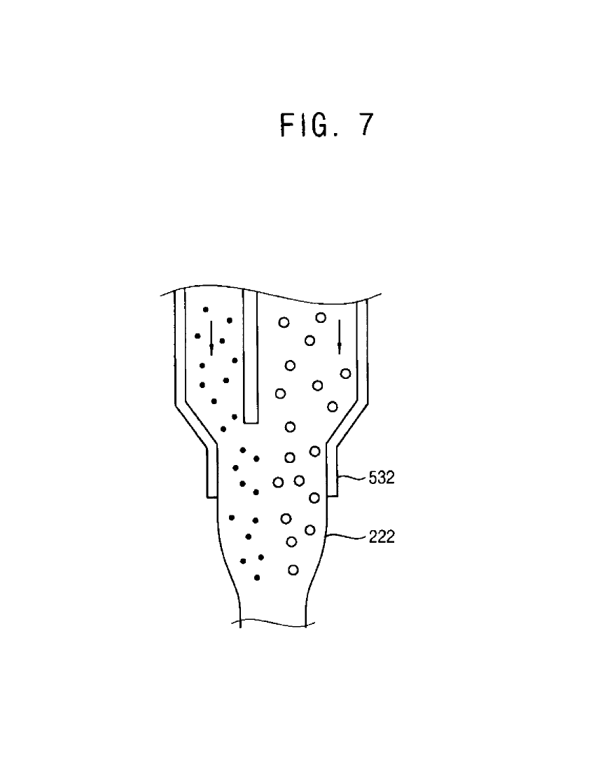

FIG. 7 is an enlarged cross-sectional view illustrating an exemplary embodiment of a discharge hole of an extruder used in a method of manufacturing a light diffusion plate according to the invention. Referring to FIG. 7, a resin to form the light diffusion plate is extruded through a single discharge hole 532 defined by a body of the extruder. An exemplary embodiment of a method of manufacturing the light diffusion plate according to the invention includes mixing a first resin with the light scattering member and mixing a second resin with the UV absorption member. The first and second resins may be mixed separately from each other, but not limited thereto or thereby. The method further includes extruding the mixed first resin and/or the mixed second resin through a discharge hole to form a light diffusion plate. The resin 222 including a mixed member therein and extruded through the single discharge hole 532 gradually forms the light diffusion plate from a lower portion to an upper portion (or, from an upper portion to a lower portion). As illustrated in FIG. 7 the separately mixed first resin and the separately mixed second resin may be simultaneously extruded through the single discharge hole 532. Alternatively, the separately mixed first resin and the separately mixed second resin may be alternately extruded through the single discharge hole 532.

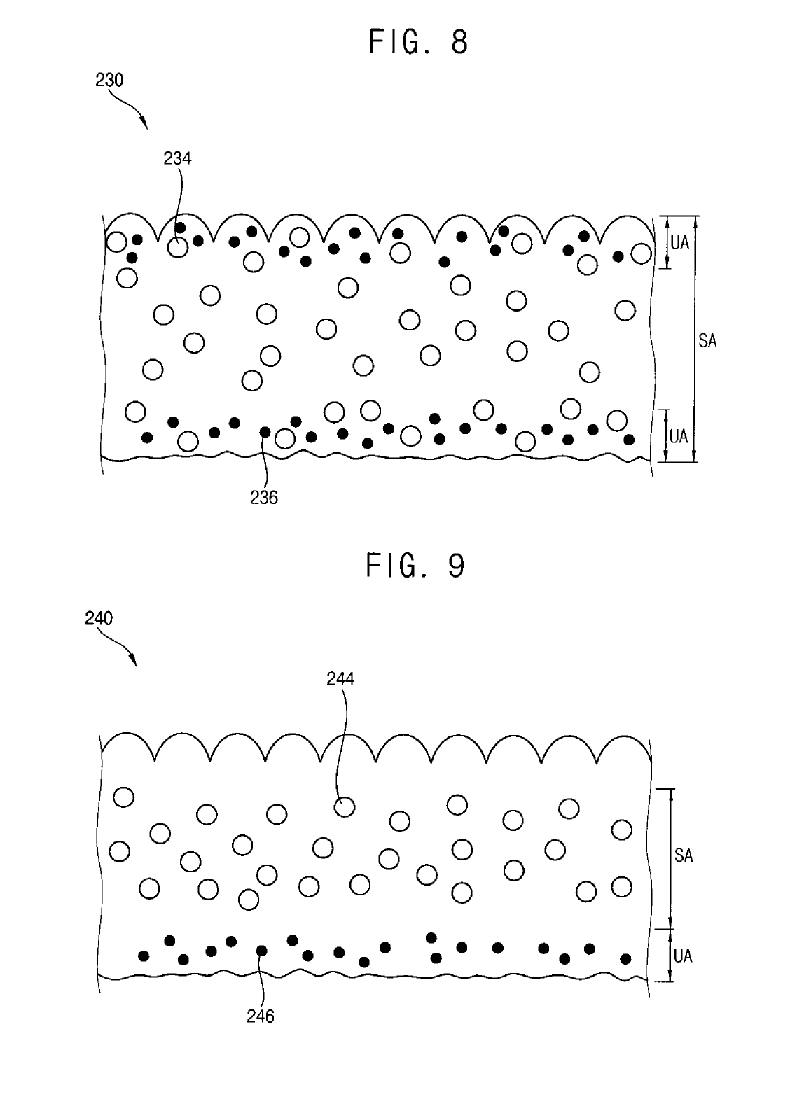

FIG. 8 is a cross-sectional view illustrating another exemplary embodiment of a light diffusion plate according to the invention.

The exemplary embodiment of a light diffusion plate 230 according to the invention includes a light scattering member 234 and a UV absorption member 236, disposed on a body thereof. The light diffusion plate 230 illustrated in FIG. 8 is different from the light diffusion plate 220 illustrated in FIGS. 1 to 4 with respect to areas in which the light scattering member 234 and the UV absorption member 236 are disposed. Thus, any further detailed descriptions concerning the same elements will be omitted.

The light diffusion plate 230 diffuses light emitted from a light source to improve luminance uniformity of light emitted from the light source. The light diffusion plate 230 has a plate shape having a desired thickness, and includes transparent material. The light diffusion plate 230 includes a body having a light entering surface through which incident light enters, and a light exiting surface through which diffused light is emitted and facing the light entering surface. The light exiting surface has a first convex pattern including ridges and valleys sequentially arranged according to a plurality of columns. The light entering surface may have a second convex pattern smaller than the first convex pattern and the second convex pattern is an irregular pattern. The first convex pattern has a regular convex pattern. In one exemplary embodiment, for example, the first convex pattern may have an arc shape of an ellipse.

The light diffusion plate 230 includes the light scattering member 234 disposed in the body and scattering the light, and the UV absorption member 236 disposed in the body and absorbing UV light. The light diffusion plate 230 may include a plurality of light scattering members 234 and/or a plurality of UV absorption members 236 disposed in the body thereof. An entire of the body may include a same material. In one exemplary embodiment, for example, the body of the light diffusion plate 230 may include polycarbonate. The light diffusion plate 230 has a single layer structure in which the scattering member 234 and the UV absorption member 236 are included in a same layer while areas of the light diffusion plate 230 in which each member is disposed are overlapped.

Referring to FIG. 8, for example, a portion of a first area SA in which the light scattering member 234 is disposed may be overlapped with a second area UA in which the UV absorption member 236 is disposed. In particular, the light scattering member 234 may be disposed in substantially a whole first area SA between the light entering surface and the light exiting surface of the light diffusion plate 230. Also, the second area UA may be overlapped with opposite end portions of the first area SA at the between the light entering surface and the light exiting surface, respectively. Furthermore, the light scattering member 234 and the UV absorption member 236 may be disposed in the first convex pattern of the light exiting surface.

As mentioned above, one or more exemplary embodiment of the light diffusion plate has a single layer structure may include substantially an entire of the body of a same material, the light scattering member and the UV absorption member disposed within the body, and the light exiting surface of the body having the first convex pattern including ridges and valleys sequentially arranged according to a plurality of columns, to improve diffusivity of light vertically emitted from the direct-illumination type backlight assembly.

FIG. 9 is a cross-sectional view illustrating still another exemplary embodiment of a light diffusion plate according to the invention.

The exemplary embodiment of a light diffusion plate 240 according to the invention includes a light scattering member 244 and a UV absorption member 246, disposed in a body thereof. The light diffusion plate 240 illustrated in FIG. 9 is different from the light diffusion plate 220 illustrated in FIGS. 1 to 4 with respect to areas in which the light scattering member 244 and the UV absorption member 246 are disposed. Thus, any further detailed descriptions concerning the same elements will be omitted.

The light diffusion plate 240 diffuses light emitted from a light source to improve luminance uniformity of light emitted from the light source. The light diffusion plate 240 has a plate shape having a desired thickness, and includes transparent material. The light diffusion plate 240 includes a body having a light entering surface through which incident light enters, and a light exiting surface through which diffused light is emitted and facing the light entering surface. The light exiting surface has a first convex pattern including ridges and valleys sequentially arranged according to a plurality of columns. The light entering surface may have a second convex pattern smaller than the first convex pattern and the second convex pattern is an irregular pattern. The first convex pattern has a regular convex pattern. In one exemplary embodiment, for example, the first convex pattern may have an arc shape of an ellipse.

The light diffusion plate 240 includes the light scattering member 244 disposed in the body and scattering the light and the UV absorption member 246 disposed in the body and absorbing UV light. The light diffusion plate 240 may include a plurality of light scattering members 244 and/or a plurality of UV absorption members 246 disposed in the body thereof. An entire of the body may include a same material. In one exemplary embodiment, for example, the body of the light diffusion plate 240 may include polycarbonate. The light diffusion plate 240 has a single layer structure in which the light scattering member 244 and the UV absorption member 246 are included in a same layer while areas of the light diffusion plate 240 in which each member is disposed are different. Referring to FIG. 9, for example, a portion of a first area SA in which the light scattering member 244 is disposed may be closer to the light exiting surface than a second area UA in which the UV absorption member 246 is disposed. Also, the first area SA may not be overlapped with the first convex pattern. The light scattering member 244 may be disposed under the first convex pattern and spaced apart from the first convex pattern by a desired distance.

According to one or more exemplary embodiment, a light diffusion plate may include an entire of a body including a same material, a light scattering member and an ultraviolet absorption member disposed within the body, and a light exiting surface of the body having a convex pattern including ridges and valleys sequentially arranged according to a plurality of columns, to improve diffusivity of light emitted from the direct-illumination type backlight assembly.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A light diffusion plate comprising:
a body comprising a first surface through which incident light enters, and a second surface facing the first surface, wherein the second surface comprises a convex pattern, the convex pattern comprises ridges and valleys arranged in a plurality of columns, and the ridges and valleys are sequentially arranged;
a light scattering member in the body; and
an ultraviolet absorption member in the body.

2. The light diffusion plate of claim 1, wherein the convex pattern has a cross-sectional shape of an arc of an ellipse.

3. The light diffusion plate of claim 2, wherein the ellipse satisfies the following Equations:
$$\begin{matrix}tan θ = \frac{2 H}{p} = α , & Equation 1 \\ a / b = γ , & Equation 2 \\ H = a - a \sqrt{1 - \frac{{p}^{2}}{4 {b}^{2}}} ↔ {( \frac{H}{p / 2} )}^{2} + {( a / b )}^{2} = ( \frac{H}{p / 2} ) ( \frac{4 α}{p} ) , & Equation 3 \\ a = \frac{p}{4 α} ( {α}^{2} + {γ}^{2} ) , & Equation 4 \\ b = \frac{p}{4} ( \frac{α}{γ} + \frac{γ}{α} ) , \\ and & Equation 5 \\ F = \frac{p}{4 α} ( \frac{α}{γ} + \frac{γ}{α} ) \frac{\sqrt{{γ}^{2} - 1}}{γ} . & Equation 6\end{matrix}$$
wherein θ represents a distance from a valley to a ridge of the arc, H represents a height from the valley to the ridge, p represents a width of the arc, a represents a semi major axis of the ellipse, b represents a semi minor axis of the ellipse, and F represents a focal length of the ellipse.

4. The light diffusion plate of claim 1, wherein an angle between a valley and a ridge of the convex pattern is from about 40 degrees to about 45 degrees with respect to the first surface.

5. The light diffusion plate of claim 1, wherein a size of the light scattering member is from about 0.1 micrometer to about 4 micrometers.

6. The light diffusion plate of claim 1, wherein
a first cross-sectional area of the body comprises the light scattering member and a second cross-sectional area of the body comprises the ultraviolet absorption member, and
the first cross-sectional area excludes the second cross-sectional area.

7. The light diffusion plate of claim 6, wherein the light scattering member is closer to the second surface of the body than the ultraviolet absorption member.

8. The light diffusion plate of claim 6, wherein the first cross-sectional area excludes the convex pattern.

9. The light diffusion plate of claim 1, wherein
a first cross-sectional area of the body comprises the light scattering member and a second cross-sectional area of the body comprises the ultraviolet absorption member, and
the first and second cross-sectional areas overlap each other.

10. The light diffusion plate of claim 1, wherein the body comprises polycarbonate.

11. The light diffusion plate of claim 1, wherein the light scattering member is in the convex pattern.

12. A display apparatus comprising:
a light source generating and emitting light;
a light diffusion plate comprising
a body comprising a light incident surface, and a light exiting surface facing the light incident surface and through which the light is emitted, wherein the light exiting surface comprises a convex pattern, and the convex pattern comprises ridges and valleys arranged in a plurality of columns;
a light scattering member in the body; and
an ultraviolet absorption member in the body; and
a display panel on the light diffusion plate and displaying an image using the light emitted from the light exiting surface of the light diffusion plate.

13. The display apparatus of claim 12, wherein the convex pattern has a cross-sectional shape of an arc of an ellipse.

14. The display apparatus of claim 12, wherein an angle between a valley and a ridge of the convex pattern is from about 40 degrees to about 45 degrees with respect to the light incident surface of the light diffusion plate.

15. The display apparatus of claim 12, wherein a size of the light scattering member is from about 0.1 micrometer to about 4 micrometers.

16. The display apparatus of claim 12, wherein
a first cross-sectional area of the body comprises the light scattering member and a second cross-sectional area of the body comprises the ultraviolet absorption member, and
the first cross-sectional area excludes the second cross-sectional area.

17. A method of manufacturing a light diffusion plate, the method comprising:
mixing a light scattering member with a first resin material to form a first resin;
mixing an ultraviolet absorption member with a second resin material to form a second resin; and
extruding the first resin or the second resin through a discharge hole to form the light diffusion plate.

18. The method of manufacturing the light diffusion plate of claim 17, wherein the extruding the first resin or the second resin through the discharge hole to form the light diffusion plate comprises extruding the first resin and the second resin simultaneously through the discharge hole.

19. The method of manufacturing the light diffusion plate of claim 17, wherein the extruding the first resin or the second resin through the discharge hole to form the light diffusion plate comprises extruding the first resin and the second resin alternately through the discharge hole.
